(19) United States
(12) Patent Application Publication
(10) Pub. No.: US 2018/0350108 A1
(43) Pub. Date: Dec. 6, 2018

(54) Smart Hitch Assistant System

(71) Applicants: DENSO International America, Inc., Southfield, MI (US); DENSO CORPORATION, Kariya-shi (JP)

(72) Inventor: Bingchen WANG, Novi, MI (US)

(21) Appl. No.: 15/608,431

(22) Filed: May 30, 2017

(51) Int. Cl. G06T 7/80; H04N 17/00; H04N 7/18

(52) U.S. Cl. CPC G06T 7/85; H04N 7/181; H04N 17/002

(57) ABSTRACT

A system for determining an estimated backup path or forward path of a trailer hitched to a vehicle. The system includes two cameras for identifying hitch angle without reliance on a predetermined target having a known shape or known dimensions, such as by using automatic camera calibration. The system determines trailer width and trailer tip location without relying on stored trailer parameters.

### FIELD

The present disclosure relates to a smart hitch assistant system for steering a vehicle with a trailer.

### BACKGROUND

This section provides background information related to the present disclosure, which is not necessarily prior art.

Current systems and methods for assisting a driver with steering a vehicle with a trailer are suitable for their intended use, but are subject to improvement. For example, many current systems and methods undesirably require identification of a particular target having a known shape and/or dimensions at or of a trailer to calculate trailer hitch angle. Other systems and methods undesirably rely on stored trailer parameters to determine trailer tip location and trailer width. The present teachings overcome such shortcomings in the art and provide numerous advantages, as set forth herein and as one skilled in the art will recognize.

### SUMMARY

This section provides a general summary of the disclosure, and is not a comprehensive disclosure of its full scope or all of its features.

The present teachings advantageously include two cameras for identifying hitch angle without reliance on a predetermined target having a known shape or known dimensions. The present teachings can also advantageously determine trailer width and trailer tip location without relying on stored trailer parameters, which often must be undesirably manually entered or selected. The present teachings provide numerous additional advantages as set forth herein, and as one skilled in the art will appreciate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates a system according to the present teachings for determining an estimated backup path or forward path of a trailer hitched to a vehicle;

FIG. 2 illustrates a control module according to the present teachings included with the system of FIG. 1;

FIG. 3A illustrates the vehicle and the trailer of FIG. 1 aligned in a straight path;

FIG. 3B illustrates the vehicle and the trailer of FIG. 1 with the trailer misaligned relative to the vehicle;

FIG. 4 illustrates calibration of a vehicle rear camera mounted to the vehicle and a trailer camera mounted to the trailer;

FIG. 5 illustrates a method in accordance with the present teachings for determining an estimated path of the trailer hitched to the vehicle; and

FIG. 6 illustrates detection of a width of the trailer in accordance with the present teachings.

Corresponding reference numerals indicate corresponding parts throughout the several views of the drawings.

### DETAILED DESCRIPTION

Example embodiments will now be described more fully with reference to the accompanying drawings.

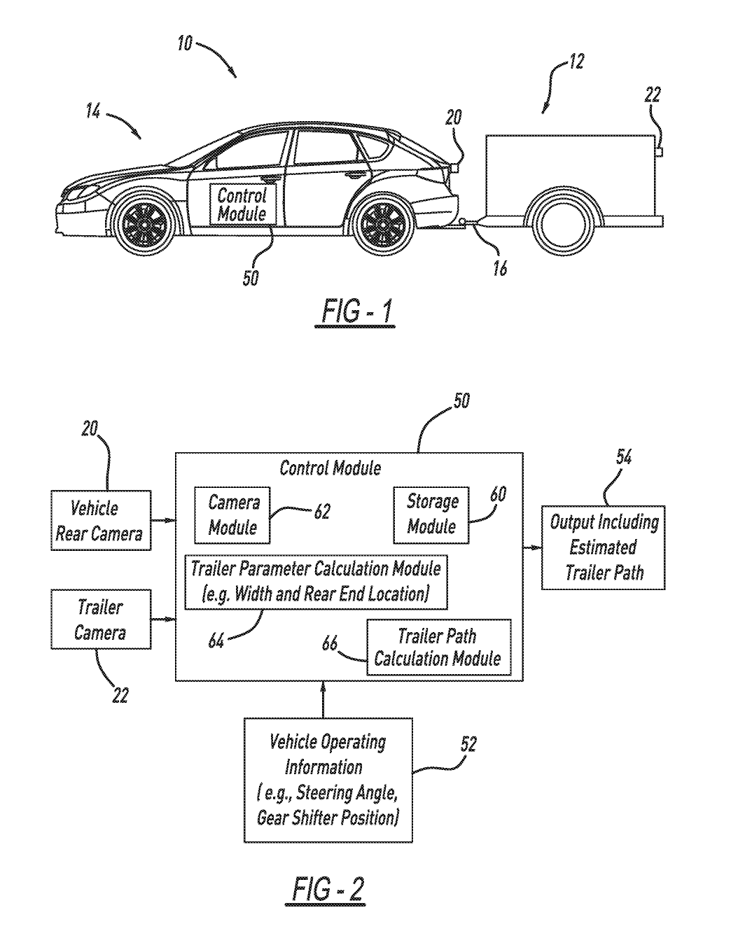

FIG. 1 illustrates a system 10 in accordance with the present teachings for determining an estimated backup path of a trailer 12 hitched to a vehicle 14 with any suitable trailer hitch 16. The present teachings are also applicable to forward driving to pull the trailer 12 in a suitable manner, such as to avoid a jackknife situation. Although the vehicle 14 is generally illustrated as a passenger vehicle, the present teachings are applicable for use with any suitable type of vehicle, such as any suitable type of passenger vehicle, utility vehicle, construction equipment, military equipment, etc. The trailer 12 can be any type of trailer suitable for being hitched to any suitable vehicle. For example, the trailer 12 can be a camping trailer, equipment trailer, military trailer, etc.

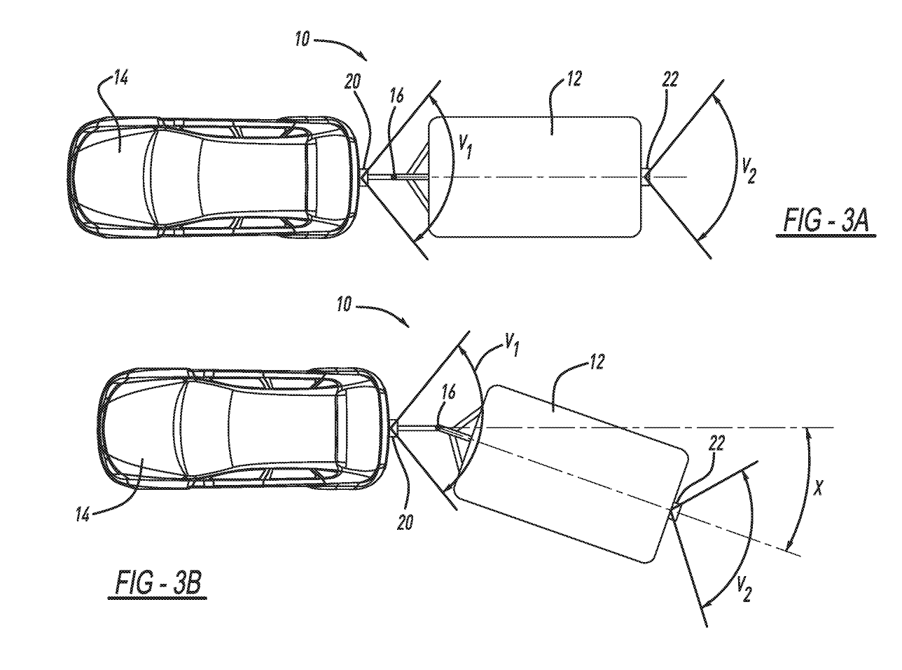

Mounted to the vehicle 14 is a vehicle rear camera 20. The vehicle rear camera 20 can be mounted at any suitable position on the vehicle 14, such as at a rear end of the vehicle 14. The vehicle rear camera 20 can be mounted on a rear surface of the vehicle 14, or on a side surface of the vehicle 14. Mounted to the trailer 12 is a trailer camera 22. The trailer camera 22 can be mounted at any suitable position on the trailer 12, such as at a rear end of the trailer 12. As described further herein, the trailer camera 22 can be used to identify the rear end of the trailer 12, and thus the trailer camera 22 can be mounted to a rear-most portion of the trailer 12, for example. FIGS. 3A and 3B illustrate exemplary fields of view of the cameras 20 and 22. In the example illustrated, vehicle rear camera 20 has a field of view V₁, and trailer camera 22 has a field of view V₂.

The cameras 20 and 22 may be any suitable type of cameras or sensors configured to view and/or sense the environment about the vehicle 14 and the trailer 12 respectively. For example, the rear vehicle camera 20 can be any suitable type of camera configured to view and/or sense the position of the trailer 12 relative to the vehicle 14, as well as the environment about the rear of the vehicle 14. The trailer camera 22 can be any suitable camera configured to view and/or sense the environment about the rear of the trailer 12, based upon which the position of the trailer 12 relative to the vehicle 14 can be determined as described in detail herein.

The system 10 further includes a control module 50, which in FIG. 1 is illustrated as installed onboard the vehicle 14. FIG. 2 illustrates the control module 50 in greater detail, as well as inputs and outputs to/from the control module 50. In this application, including the definitions below, the term “module” or the term “control module” may be replaced with the term “circuit.” The terms “module” and “control module” may refer to, be part of, or include processor hardware (shared, dedicated, or group) that executes code and memory hardware (shared, dedicated, or group) that stores code executed by the processor hardware. The code is configured to provide the features of the modules, control modules, and systems described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The control module 50 receives inputs from the vehicle rear camera 20 and the trailer camera 22. From the vehicle rear camera 20, the control module 50 receives image data regarding the environment about the rear of the vehicle 14, including the position of the trailer 12 relative to the vehicle 14. From the trailer camera 22, the control module 50 receives image data representing the environment about the rear of the trailer 12.

The control module 50 is further in receipt of vehicle operating information 52. The vehicle operating information 52 includes any relevant operating information of the vehicle 14, such as steering angle and gear shift position. The vehicle operating information can be received from any suitable onboard module or control unit.

The control module 50 further includes any suitable storage module 60, a camera calibration module 62, a trailer parameter calculation module 64, and a trailer path calculation module 66. Based on the inputs to the control module 50, the control module 50 is configured to determine an output at 54 including an estimated trailer path of the trailer 12. The output 54 including the estimated trailer path can be used in any suitable manner. For example, the output 54 can be relayed to any suitable display module for displaying to an operator of the vehicle 14 an estimated backup path of the trailer 12. For example, the estimated trailer path of the trailer 12 may be overlaid upon an image of the area behind the trailer 12 captured by the trailer camera 22 in any suitable manner. The driver of the vehicle 14 can then advantageously compare the image and the estimated trailer path to facilitate backup of the trailer 12 and the vehicle 14.

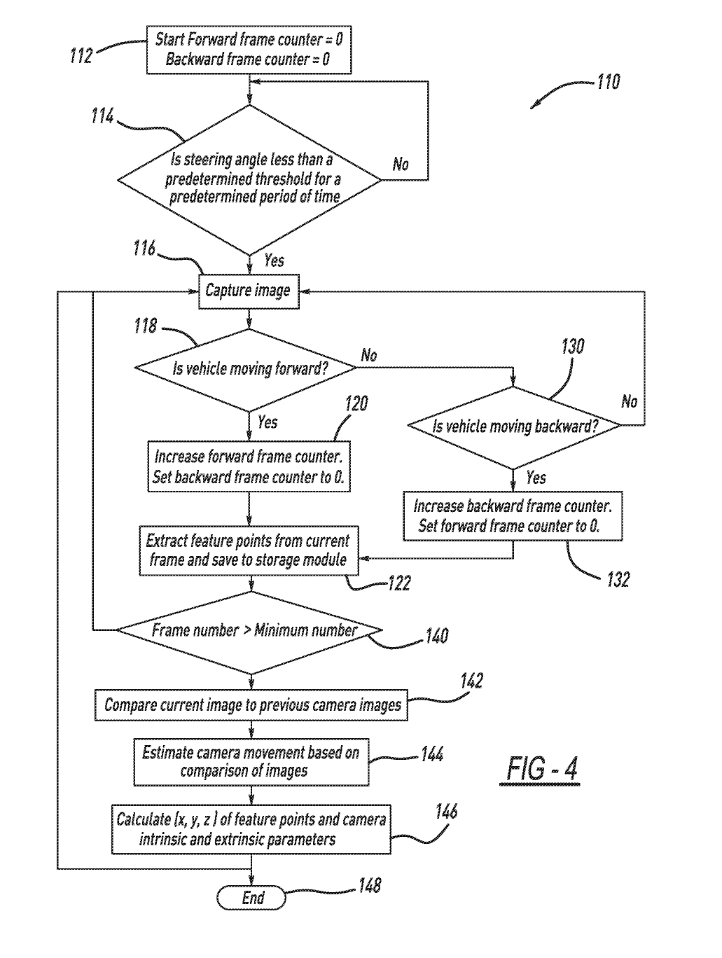

FIG. 4 illustrates automatic camera calibration 110, which is individually performed for each one of the vehicle rear camera 20 and the trailer camera 22. The automatic camera calibration 110 can be performed by the camera module 62 for example. With reference to block 112 of FIG. 4, the camera module 62 starts both a forward frame counter and a backward frame counter at count 0. At block 114, the control module 50 determines whether the steering angle of the vehicle 14 is less than a predetermined threshold for a predetermined period of time based on vehicle operating information 52 input to the control module 50.

At block 116, the camera module 62 operates the cameras 20 and 22 to capture an image. Although auto camera calibration is primarily described herein as using images, any other suitable information can be used for camera calibration. For example, vehicle movement information (speed, yaw rate, etc.) can be used to improve camera performance. At block 118, the control module 50 determines whether the vehicle 14 is moving forward in any suitable manner, such as based on the gear shifter position input to the control module 50 from vehicle operating information 52. If the vehicle is moving forward, at block 120 the camera module 62 increases the forward frame counter by 1 and sets the backwards frame counter at 0. At block 122, the camera module 62 extracts feature points from the currently captured image frame and saves the feature points to the storage module 60. If at block 118 the control module 50 determines that the vehicle 14 is not moving forward, at block 130 the control module 50 determines whether the vehicle 14 is moving backwards, such as based on the vehicle operating information 52. For example, the control module 50 will determine that the vehicle 14 is moving backwards when the vehicle operating information 52 indicates that the gear shifter has been shifted to reverse. At block 132, the camera module 62 increases the backward frame counter, and sets the forward frame counter to 0. From block 132, the auto camera calibration proceeds to block 122.

From block 122, the automatic camera calibration 110 proceeds to block 140. At block 140 the control module 50 determines whether the number of frames captured is greater than a predetermined number. If the number of frames captured is below the predetermined number, the automatic camera calibration returns to block 116 and captures additional frames until the number of frames captured is greater than the predetermined minimum number of frames. Once the predetermined number of frames has been captured, the automatic camera calibration proceeds to block 142.

At block 142, the camera module 62 compares the current image captured by the vehicle rear camera 20 with previous images captured by the vehicle rear camera 20, and compares the current image captured by the trailer camera 22 with previous camera images captured by the trailer camera 22. At block 144, the camera module 62 estimates movement of the vehicle rear camera 20 based on the comparison of the images captured by the vehicle rear camera 20. Likewise, the camera module 62 estimates camera movement of the trailer camera 22 based on comparison of the images captured by the trailer camera 22.

With reference to block 146, the images can be compared in any suitable manner based on any suitable feature points. For example, the feature points compared may include one or more of the following: lane markers, road cracks, road texture, or any other suitable objects or features about the trailer 12 and the vehicle 14. The feature points need not be predetermined, and thus need not include predetermined targets having fixed patterns, known shapes, or known dimensions. Comparing the relative locations of the feature points in the different images (such as the X, Y, Z coordinates thereof) allows the control module 50 to determine movement of the vehicle rear camera 20 and the trailer camera 22, and particularly movement of the trailer camera 22 relative to the vehicle rear camera 20. Based on this relative movement, the hitch angle of the trailer hitch 16 is determined.

For example, when the vehicle 14 and the trailer 12 are aligned in a straight line (see FIG. 3A), such as when driving down a straight road, image frames from the vehicle rear camera 20 and the trailer camera 22 are captured, and stored in the storage module 60. Images from the cameras 20 and 22 are continuously captured, and the locations of the feature points are continuously stored in the storage module 60. When the vehicle 14 is in reverse and turning, additional images are captured and the locations of the feature points of the additional image frames are compared to the image frames captured when the vehicle 14 and the trailer 12 are aligned and traveling along a straight path. Based on the change in positions of the feature points, the camera module 62 determines movement of the trailer camera 22 relative to the vehicle rear camera 20. Movement of the trailer camera 22 relative to the vehicle rear camera 20 corresponds to change in trailer hitch angle of the trailer hitch 16 from 0°, or relatively 0°, when the vehicle 14 and the trailer 12 are traveling a straight line as illustrated in FIG. 3A, to a hitch angle X that is greater than 0° as illustrated in FIG. 3B. Images can be repeatedly captured at block 116, and the automatic camera calibration 110 can repeatedly proceed to block 146. The automatic camera calibration 110 ends at block 148 in any suitable manner and at any suitable time, such as when a backup assistance system of the vehicle 14 is deactivated, the vehicle 14 is turned off, or when the vehicle 14 has not been operated in reverse for a predetermined period of time.

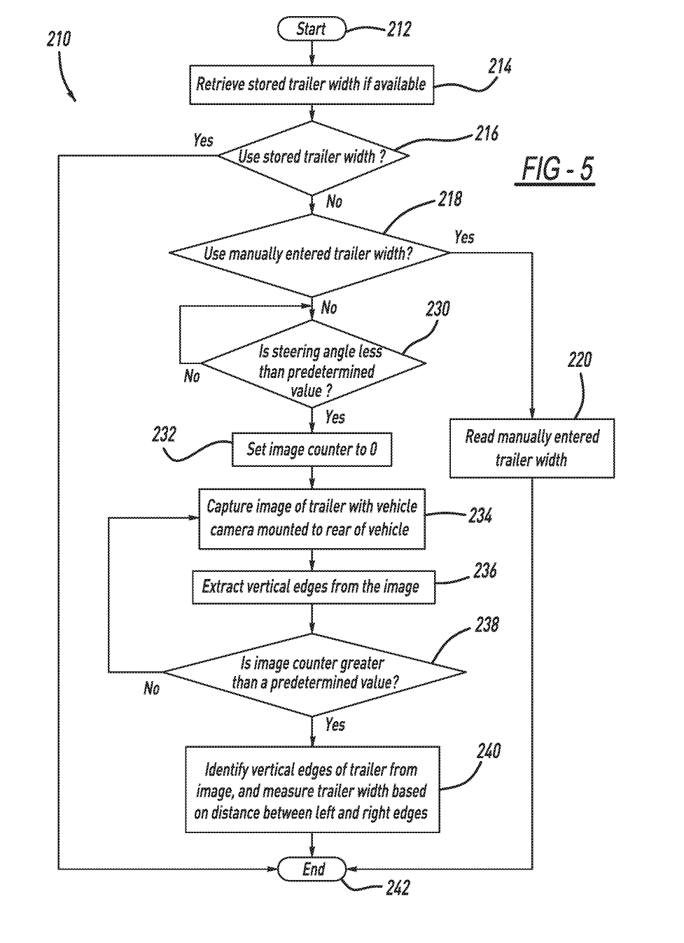

FIG. 5 illustrates detection of a maximum width of the trailer 12 at reference numeral 210. Trailer width detection 210 starts at block 212, and proceeds to 214 where a stored trailer width of the trailer 12 is retrieved, such as from the storage module 60, if the width was previously stored therein by an original equipment manufacturer, secondary supplier, service provider, user, etc. At block 216, the control module 50 determines whether or not to use the stored trailer width, if available. For example, if an operator of the vehicle 14 decides to use the stored trailer width and a stored trailer width is available, trailer width detection 210 is complete, and proceeds to end block 242. If there is no stored trailer width or the user decides to not use the stored trailer width, trailer width detection 210 proceeds to block 218 where the control module 50 determines whether to use a manually entered trailer width. For example, if the operator of the vehicle 14 manually enters a trailer width and instructs the control module 50 to use the manually input trailer width, such as using any suitable user interface to enter a corresponding command, the manually entered trailer width is read at block 220 and used. The trailer width detection 210 then proceeds to end block 242. If at block 218 a manually entered trailer width is not used, the trailer width detection 212 proceeds to block 230.

At block 230, the control module 50 determines whether a steering angle of the vehicle 14 is less than a predetermined value based on vehicle operating information 52. Once the steering angle is less than the predetermined value, trailer width detection 210 proceeds to block 232. At block 232, the camera module 62 sets an image counter for the vehicle rear camera to 0. At block 234, the camera module 62 captures an image of the trailer 12 with the vehicle rear camera 20, and increases the image camera counter each time an image is captured. At block 236, the trailer parameter calculation module 64 extracts vertical edges from the images captured. At block 238, once the image counter has exceeded a predetermined value, indicating that a sufficient number of images of the width of the trailer 12 have been taken, trailer width detection 210 proceeds to block 240. If at block 238 an insufficient number of images have been taken, trailer width detection 210 returns to block 234 for additional images to be captured. At block 240, the trailer parameter calculation module 64 identifies the vertical edges of the trailer 12 and measures trailer width based on the distance between the left and right edges. After the trailer width has been detected, trailer width detection ends at block 242.

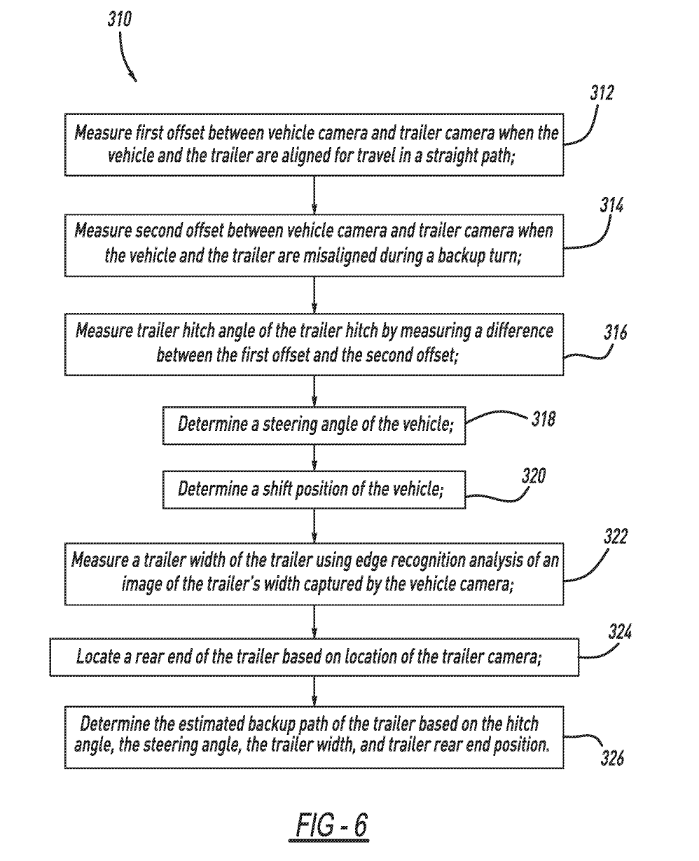

FIG. 6 sets forth a method in accordance with the present teachings at reference numeral 310 for determining an estimated path of a trailer hitched to a vehicle. The method 310 can be used to determine an estimated backup path, or forward path of travel. The method 310 can be performed by the system 10, or any other suitable system. The method 310 is described with reference to the system 10 for exemplary purposes only. With reference to block 312, camera calibration is performed or re-checked by measuring a first offset between the vehicle rear camera 20 and the trailer camera 22 when the vehicle 14 and the trailer 12 are aligned for travel in a straight path, such as in the manner set forth in FIG. 4 and the accompanying description set forth above. This measurement can be performed by the camera module 62 as explained above. When the vehicle 14 and the trailer 12 are aligned in a straight path, there should be little or no offset between the vehicle rear camera 20 and the trailer camera 22, as illustrated in FIG. 3A for example.

At block 314, the second offset is measured between the vehicle rear camera 20 and the trailer camera 22, such as by the camera module 62 as described above, when the vehicle 14 and the trailer 12 are misaligned, such as during a backup turn as illustrated in FIG. 3B. At block 316, the camera module 62, or the control module 50, can measure a trailer hitch angle (see angle X of FIG. 3B) of the trailer hitch 16 by measuring a difference between the first offset and the second offset. In other words, movement of the trailer camera 22 relative to the vehicle rear camera 20 during a backup turn is measured, such as by automatic camera calibration 110 described above. Automatic camera calibration 110 advantageously determines relative camera movement based on movement of feature points. Movement of the feature points in different images corresponds to relative movement of the cameras 20 and 22, and relative movement of the cameras 20 and 22 corresponds to a change in trailer hitch angle X of the trailer hitch 16.

At block 318, steering angle of the vehicle 14 is determined based on vehicle operating information 52. At block 320, shift position of the vehicle 14 is determined based on position of the gear shifter of the vehicle 14. At block 322, trailer width of the trailer 12 is measured, such as by using edge recognition analysis of an image of the width of the trailer 12 taken by the vehicle rear camera 20. Trailer width detection 210 of FIG. 5 described above can be used.

At block 324, the rear end of the trailer 12 is located based on location of the trailer camera 22. The trailer camera 22 can capture an image of the rear end of the trailer 12, for example. The trailer camera 22 can also be positioned at the rear edge of the trailer 12. At block 326, the trailer path calculation module 66 determines an estimated backup path of the trailer 12 based on the hitch angle, the steering angle, the trailer width, the trailer end position, and any other suitable parameters. The estimated backup path of the trailer 12 is output at block 54 of FIG. 2, and can be displayed to the driver using any suitable driver interface to assist the driver with operating the vehicle 14 in reverse with the trailer 12 hitched thereto.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method for determining an estimated backup path or forward path of a trailer hitched to a vehicle with a trailer hitch, the method comprising:
capturing images with a vehicle camera mounted to the vehicle;
capturing images with a trailer camera mounted to the trailer;
comparing the images captured with the trailer camera to the images captured with the vehicle camera to identify movement of the trailer camera relative to the vehicle camera; and
measuring a trailer hitch angle of the trailer based on movement of the trailer camera relative to the vehicle camera.

2. The method of claim 1, further comprising:
extracting feature points from the images captured with the trailer camera, and comparing locations of the feature points in the different images captured with the trailer camera to identify movement of the trailer camera and the trailer; and
extracting feature points from the images captured with the vehicle camera, and comparing locations of the feature points in the different images captured with the vehicle camera to identify movement of the vehicle camera and the vehicle.

3. The method of claim 1, further comprising identifying where the tip of the trailer is located based on position of the trailer camera.

4. The method of claim 1, further comprising measuring trailer width with edge recognition analysis of an image of the trailer's width captured by the vehicle camera.

5. The method of claim 1, wherein the trailer hitch angle is a yaw angle of the trailer relative to the vehicle.

6. The method of claim 1, wherein the vehicle camera is mounted at a rear of the vehicle.

7. The method of claim 1, wherein the vehicle camera is mounted at a side of the vehicle.

8. The method of claim 1, wherein the trailer camera is mounted at a rear of the trailer.

9. The method of claim 1, further comprising using automatic camera calibration to measure the trailer hitch angle of the trailer based on movement of the trailer camera relative to the vehicle camera.

10. A method for determining an estimated backup path or forward path of a trailer hitched to a vehicle, the method comprising:
capturing images with a vehicle camera mounted to the vehicle oriented to capture images of the trailer;
capturing images with a trailer camera mounted to a rear end of the trailer;
comparing the images captured with the trailer camera to the images captured with the vehicle camera to identify movement of the trailer camera relative to the vehicle camera;
measuring a trailer hitch angle of the trailer based on movement of the trailer camera relative to the vehicle camera;
determining a steering angle of the vehicle;
determining a shift position of the vehicle;
measuring a trailer width of the trailer using edge recognition analysis of an image of the trailer's width captured by the vehicle camera;
locating a rear end of the trailer based on location of the trailer camera; and
determining at least one of the estimated backup path of the trailer and the estimated forward path of the trailer based on the trailer hitch angle, the steering angle, the trailer width, and trailer rear end position.

11. The method of claim 10, further comprising:
measuring a first offset between the trailer camera and the vehicle camera when the vehicle and the trailer are traveling in a straight line;
measuring a second offset between the trailer camera and the vehicle camera when the vehicle is making a turn in reverse;
measuring a difference between the first offset and the second offset;
wherein the trailer hitch angle is the difference between the first offset and the second offset.

12. The method of claim 10, wherein comparing the images captured with the trailer camera to the images captured with the vehicle camera includes comparing positions of feature points extracted from the images captured with the trailer camera to the images captured with the vehicle camera.

13. The method of claim 12, wherein the feature points extracted includes one or more of the following: lane markers, road cracks, and road texture.

14. The method of claim 10, further comprising using automatic camera calibration to compare the images captured with the trailer camera to the images captured with the vehicle camera to identify movement of the trailer camera relative to the vehicle camera.

15. A system for determining an estimated backup path or forward path of a trailer hitched to a vehicle, the system comprising
a vehicle camera mounted to a rear of a vehicle;
a trailer camera mounted to a rear of the trailer;
a control module that receives images from the vehicle camera and the trailer camera, the control module measures a first angle between the vehicle camera and the trailer camera when the vehicle and the trailer are aligned for travel in a straight path, and the control module measures a second angle between the vehicle camera and the trailer camera when the vehicle and the trailer are misaligned during a backup turn;
a control module that measures a trailer hitch angle of the trailer by measuring a difference between the first angle and the second angle; and
a trailer parameter calculation module that measures width of the trailer by edge recognition analysis of an image of the trailer's width captured by the vehicle camera, and locates a rear end of the trailer based on location of the trailer camera;
wherein the control module determines the estimated backup path of the trailer or forward path of the trailer based on the hitch angle, a steering angle of the vehicle, the trailer width, and location of the rear end of the trailer.

16. The system of claim 15, wherein the control module extracts feature points from the images captured by each of the vehicle camera and the trailer camera, compares relative positions of the feature points, and determines relative positions of the vehicle camera and the trailer camera based on the relative positions of the features points.

17. The system of claim 16, wherein the feature points include one or more of the following: lane markers, road cracks, and road texture.
